(19) United States
(12) Patent Application Publication
(10) Pub. No.: US 2016/0091249 A1
(43) Pub. Date: Mar. 31, 2016

(54) CRUCIBLES FOR MELTING MATERIAL AND METHODS OF TRANSFERRING MATERIAL THEREFROM

(71) Applicant: BATTELLE ENERGY ALLIANCE, LLC., IDAHO FALLS, ID (US)

(72) Inventors: BRADLEY CURTIS BENEFIEL, IDAHO FALLS, ID (US); CLARK LANDON SCOTT, IDAHO FALLS, ID (US)

(21) Appl. No.: 14/843,821

(22) Filed: Sep. 2, 2015

Related U.S. Application Data
(60) Provisional application No. 62/055,359, filed on Sep. 25, 2014.

(51) Int. Cl. F27B 14/04; F27B 14/08; F27D 15/02; F27B 14/06

(52) U.S. Cl. CPC F27B 14/04; F27B 14/065; F27B 14/0806; F27D 15/02; F27B 2014/0825; F27B 2014/045; F27B 2014/066; F27B 2014/108

(57) ABSTRACT

A crucible for melting material includes at least one wall at least partially enclosing a volume and including an orifice through a portion thereof, and a chill plate supported for movement between at least a first position covering the orifice and a second position. The chill plate is configured for removal of heat from the at least one wall when in the first position. Some crucibles include a substantially flat bottom plate, a plurality of hollow tubes above the substantially flat bottom plate proximate a periphery thereof, and a plurality of O-rings. Each hollow tube is in contact with at least one O-ring, and each O-ring is in contact with the substantially flat bottom plate. A method includes moving the chill plate, initiating flow of molten material, terminating flow of molten material, and replacing the chill plate. Flow of material may be controlled by providing a vacuum in the crucible.

### CROSS-REFERENCE TO RELATED APPLICATION

This application claims the benefit of U.S. Provisional Patent Application Ser. No. 62/055,359, filed Sep. 25, 2014, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-051D14517 awarded by the United States Department of Energy. The government has certain rights in the invention.

### FIELD

Embodiments of the present disclosure relate generally to cold crucibles that may be used for induction melting or other high-temperature processing of materials.

### BACKGROUND

Induction melting can be used to melt and heat electrically conductive materials in a crucible or furnace, having cooled walls and a cooled floor, by applying an inductive field to the crucible. Because the walls and/or floor are maintained at a relatively low temperature, such process may be referred to in the art as cold-crucible induction melting (CCIM). CCIM has the potential to simplify and reduce the cost for stabilizing high-level radioactive waste by melting the waste. The molten waste can then be solidified into a glass, glass-ceramic, or pure ceramic form for simplified handling and storage. CCIM can also be used to process other materials, such as high-purity and corrosive products. CCIM is typically an energy-intensive process.

FIG. 1 illustrates a simplified cross-sectional view of a crucible 100 that may be used in CCIM. The crucible 100 has walls 102 and a floor 104. A cooling fluid or gas 105 (typically water) passes through the walls 102 and/or the floor 104 to maintain mechanical integrity of the crucible 100. The walls 102 define a generally cylindrical interior, in which a material 108 to be melted (e.g., glass frit) is placed. An induction coil 106, connected to a suitable power supply, induces a field on the material 108 in the crucible 100, which heats the material 108, either directly or through heat conduction from an initiator (e.g., a metal ring), and the crucible 100. The cooling fluid 105 maintains the walls 102 and the floor 104 at a lower temperature than the interior of the crucible 100. Therefore, a skull 110 or solid portion of material may form adjacent the walls 102 and floor 104. The skull 110 protects the walls 102 and floor 104 while the material 108 is heated to high temperatures, and may seal gaps in the walls 102. Because of temperature gradients within the material 108, currents 114 may mix the material 108 during the heating process.

To remove the material 108 from the crucible 100, the crucible 100 may be tipped (i.e., rotated about a horizontal axis) to pour material out. Such a process is typically performed in batch mode, wherein substantially all of the molten material 108 is removed at once. In a batch process, the crucible 100 is filled with material 108 in solid form, the material 108 is melted, then the material 108 is poured from the crucible 100. Some crucibles 100 for CCIM include a mechanism to remove material 108 from the bottom or side of the crucible 100. For example, as shown in FIG. 1, a crucible 100 may include a tap 112 through the floor 104 of the crucible 100. A tap 112, which may be heated to prevent freezing of the material 108 thereon, allows molten material 108 to be removed without tipping the crucible 100, and may allow for finer flow control than simply tipping the crucible 100.

A tap 112 in the floor 104 of the crucible 100 may typically be used only once or a limited number of times. For example, a hole may be drilled or punched into the floor 104, after which all the material 108 (other than the solidified material that forms the skull 110) flows out through the tap 112. In such an operation, there is typically little control over the flow rate of the material 108, and it is typically difficult or impossible to stop flow before substantially all the molten material 108 leaves the crucible 100. A slide gate, pin, or cover may be used to close the tap 112. However, such mechanisms typically become encrusted with portions of the material 108 that solidifies thereon, making repeated use of the tap 112 difficult. Auxiliary heaters near the tap 112 may lessen this problem to an extent, but may interfere with the induction coil 106 and/or the cooling fluid 105.

### BRIEF SUMMARY

In some embodiments, a crucible for melting material includes at least one wall at least partially enclosing a volume and including an orifice through a portion thereof, and a chill plate supported for movement between at least a first position and a second position. In the first position, the chill plate is in contact with the portion of the at least one wall and covers the orifice. In the second position, the chill plate is removed from contact with the at least one wall. The chill plate is configured for removal of heat from the portion of the at least one wall when the chill plate is in the first position.

In some embodiments, a cold crucible for melting material includes a substantially flat bottom plate, a plurality of hollow tubes above the substantially flat bottom plate proximate a periphery thereof, and a plurality of O-rings. Each hollow tube of the plurality of hollow tubes is in contact with at least one O-ring of the plurality of O-rings. Each O-ring of the plurality of O-rings is in contact with the substantially flat bottom plate.

A method of transferring molten material from a crucible includes moving a chill plate from a first position to a second position, initiating flow of the molten material from the crucible through an opening through a floor of the crucible, terminating the flow of molten material from the crucible through the opening while a portion of the molten material remains in the crucible, and moving the chill plate back to the first position. In the first position, the chill plate is in contact with the floor of the crucible and covering the opening. In the second position, the chill plate is removed from the opening.

Some methods of controlling flow of material from a crucible include melting a portion of the material adjacent an opening in a wall of the crucible to initiate flow of molten material through the opening and providing a vacuum over the material in the crucible from a location opposite the opening. Flow of the molten material may be controlled (e.g., slowed or terminated) by applying a vacuum over the surface of the molten material within the crucible.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is a simplified cross-sectional side view illustrating a crucible for CCIM as known in the art;

FIG. 2A is a simplified cross-sectional side view illustrating a crucible according to the present disclosure;

FIG. 2B is a simplified cross-sectional side view illustrating a portion of the crucible of FIG. 2A in more detail;

FIG. 3 is a simplified cross-sectional side view illustrating a crucible having a chill plate covering an orifice;

FIG. 4 is a simplified cross-sectional side view illustrating the crucible of FIG. 3 with the chill plate removed from the orifice;

FIG. 5 is a simplified enlarged view of a portion of the crucible of FIG. 3 when molten material is flowing therefrom; and

FIG. 6 is a simplified enlarged view of the portion of the crucible of FIG. 3 shown in FIG. 5 when molten material has stopped flowing therefrom, and after the chill plate has been replaced.

### DETAILED DESCRIPTION

The illustrations presented herein are not actual views of any particular crucible, but are merely idealized representations that are employed to describe example embodiments of the present disclosure. Additionally, elements common between figures may retain the same numerical designation.

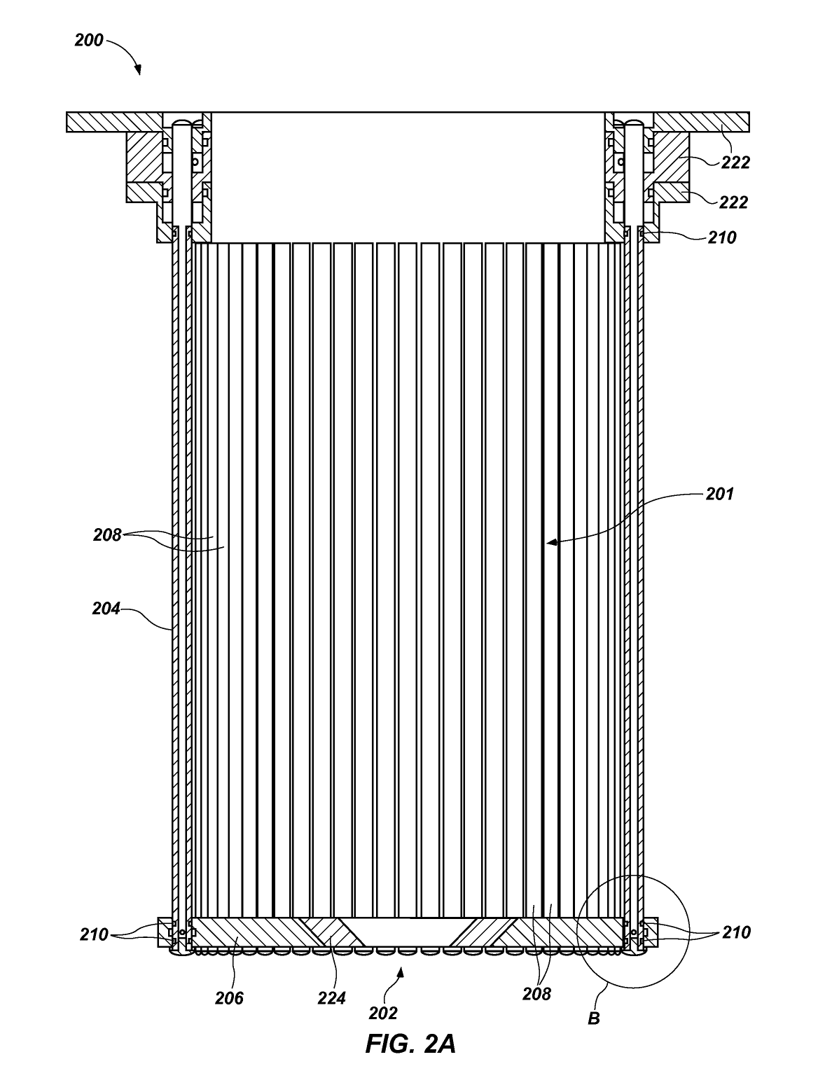

FIG. 2A illustrates an embodiment of a crucible 200 for CCIM. The crucible 200 includes at least one wall defining an enclosed volume 201 and an orifice 202 (or tap hole). In some embodiments, and as shown in FIG. 2A, the at least one wall includes a side wall 204 and a bottom plate assembly 206 (e.g., a flat plate). In other embodiments, the at least one wall may be constructed of a single wall extending around and under the enclosed volume 201. The side wall 204 may include a plurality of hollow tubes 208, which may be configured to pass a cooling fluid therethrough. FIG. 2B is an expanded detail of a portion B in FIG. 2A, but showing only one tube 208 for simplicity.

The hollow tubes 208 may be constructed of a metal or alloy, such as steel, stainless steel, copper, etc., or a ceramic, glass, or quartz material. By forming the side wall 204 of replaceable hollow tubes 208, construction of the crucible 200 may be faster and cheaper than conventional methods (e.g., brazing, welding, etc.), which typically involve high temperatures. In particular, the hollow tubes 208 may be commercially available stainless-steel pipe or tubing, and may be assembled without the use of high-temperature processes. The bottom plate assembly 206 may be constructed of a metal or alloy, such as steel, stainless steel, or copper, and/or of a ceramic, graphite, quartz, or a combination thereof. The bottom plate assembly 206 may include the same material as the hollow tubes 208, or may include a different material. For example, the hollow tubes 208 may be formed of stainless steel, and the bottom plate assembly 206 may be formed of copper.

The construction of the crucible 200 may include mechanical connections and O-ring seals rather than conventional welding or brazing. This allows for flexibility in reconfiguration of the crucible assembly. The configuration and material of construction for the hollow tubes 208 and the bottom plate assembly 206 can be changed without remanufacturing or replacing the crucible 200. This may simplify maintenance if damage to components occurs.

The hollow tubes 208 may each be connected to the bottom plate assembly 206 by a bolt 218 and washer 220. One or more O-rings 210 may form a fluid seal between each hollow tube 208 and the bottom plate assembly 206. The O-rings 210 may be installed into grooves 212 machined into the hollow tubes 208 and/or the bottom plate assembly 206.

In some embodiments, the bottom plate assembly 206 may also include one or more channels 214. For example, a channel 214 may provide a fluid connection between two or more hollow tubes 208, such as through orifices 216 in the walls of the tubes 208. When assembled, the hollow tubes 208 and bottom plate assembly 206 may together form one or more continuous flow paths for the cooling fluid via the orifices 216 and channels 214. For example, cooling fluid may flow downward through one hollow tube 208, through an orifice 216 into a channel 214 in the bottom plate assembly 206, then through an orifice 216 in an adjacent hollow tube 208. The cooling fluid may typically only pass through two hollow tubes 208 before recirculating to an external heat sink; however, in some embodiments, each flow path may include more than two of the hollow tubes 208 in series or in parallel. The bottom plate assembly 206 may also include channels disconnected from the hollow tubes 208, such as for additional cooling.

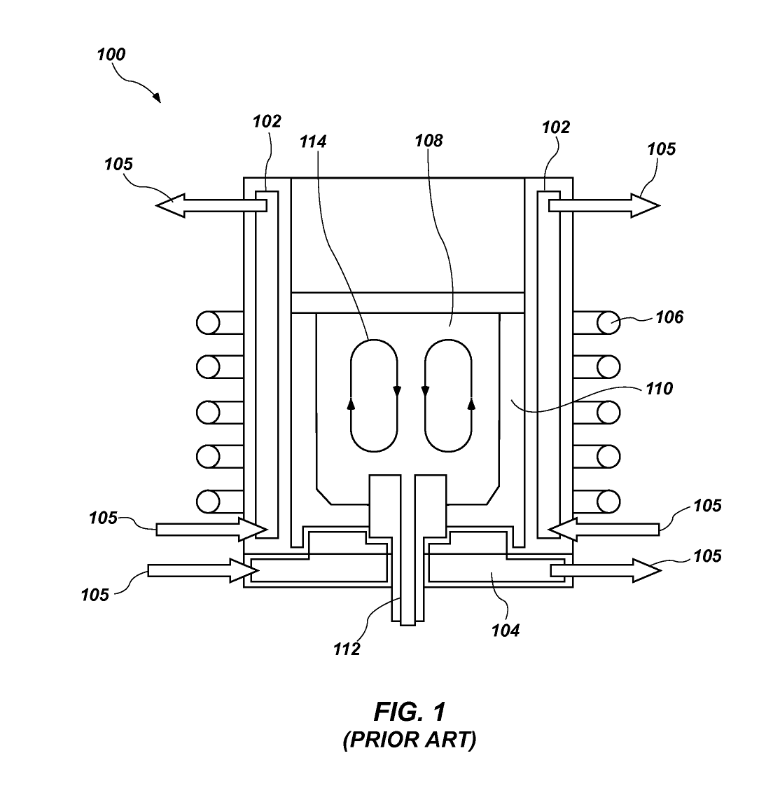

In some embodiments, the hollow tubes 208 may not touch the adjacent hollow tubes 208. In such embodiments, when material is melted within the crucible 200, some molten material may flow toward a gap between the hollow tubes 208 and solidify (due to the flow of cooling fluid in the hollow tubes 208), forming a skull 110 (see FIG. 1) and sealing the molten material within the crucible 200.

The crucible 200 may also include one or more upper retaining members 222 (e.g., rings), which may also be connected to the hollow tubes 208 by O-rings 210. Appropriate bolts, washers, etc., may be used to connect the hollow tubes 208 to the upper retaining members 222. In some embodiments, the hollow tubes 208 may be connected to the upper retaining members 222 by an interference fit, rather than by bolts. The upper retaining members 222 may include fittings to connect to a source and sink of the cooling fluid. The upper retaining members 222 may also include appropriate fluid diverters to direct cooling fluid from a fluid source to the hollow tubes 208 and then to a heat sink.

As shown in FIG. 2A, the bottom plate assembly 206 may include a conductive material 224 surrounding the orifice 202. The conductive material 224 may be electrically and/or thermally conductive. The conductive material 224 may have a melting point above the expected operating temperature of the crucible 200, such that the material within the crucible 200 (which may be molten or critically softened) does not melt the conductive material 224 when flowing through the orifice 202. A change in the composition of the conductive material 224 may correspond to a change in the amount of heat removed from a region of the crucible 200 near the orifice 202 (tap hole). In some instances, the conductive material 224 may have a relatively low thermal conductivity (i.e., the conductive material 224 may be an insulator) to allow for higher temperatures around the orifice 202 when the chill plate 340 is removed. In other embodiments, the conductive material 224 may have a relatively higher thermal conductivity to allow for lower temperatures around the orifice 202 when the chill plate 340 is removed. The composition of the conductive material 224 may be selected to adjust the temperature of material near the orifice 202. For example, the conductive material 224 may include metals such as platinum, tungsten, titanium, copper, etc., and/or graphite or ceramics such as boron nitride. The conductive material 224 may be isolated from the flow of cooling fluid (i.e., the cooling fluid may not pass through the conductive material 224).

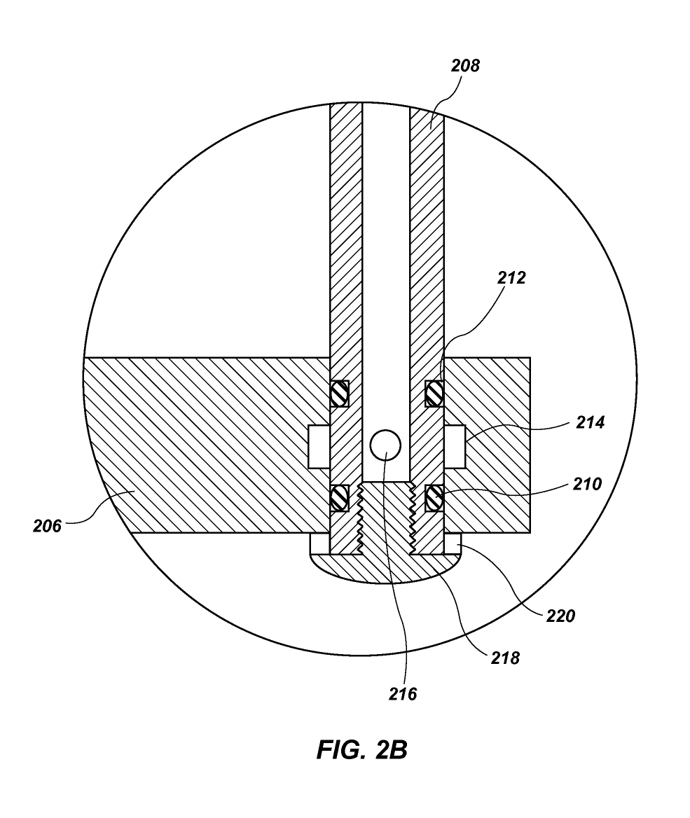

FIG. 3 illustrates another embodiment of a crucible 300 for CCIM, which may have similar design features to those illustrated in FIG. 2 (e.g., hollow tubes 208, O-rings 210, etc.). In some embodiments, the crucible 300 may include conventionally formed (e.g., welded) side walls 204 and bottom plate assembly 206. The crucible 300 may include an inductive source, shown in FIG. 3 as helical coil 330. The crucible 300 may be connected to fluid lines 332 to transfer cooling fluid to and from the crucible 300. A cover 334 may provide an air-tight seal between an interior of the crucible 300 and the environment exterior to the crucible. Cover 334 may include selectively occludable ports (not shown), such as for adding material to be melted. Fluid lines 336 may connect to the interior of the crucible 300 to provide gases or a vacuum in the crucible 300 during operation.

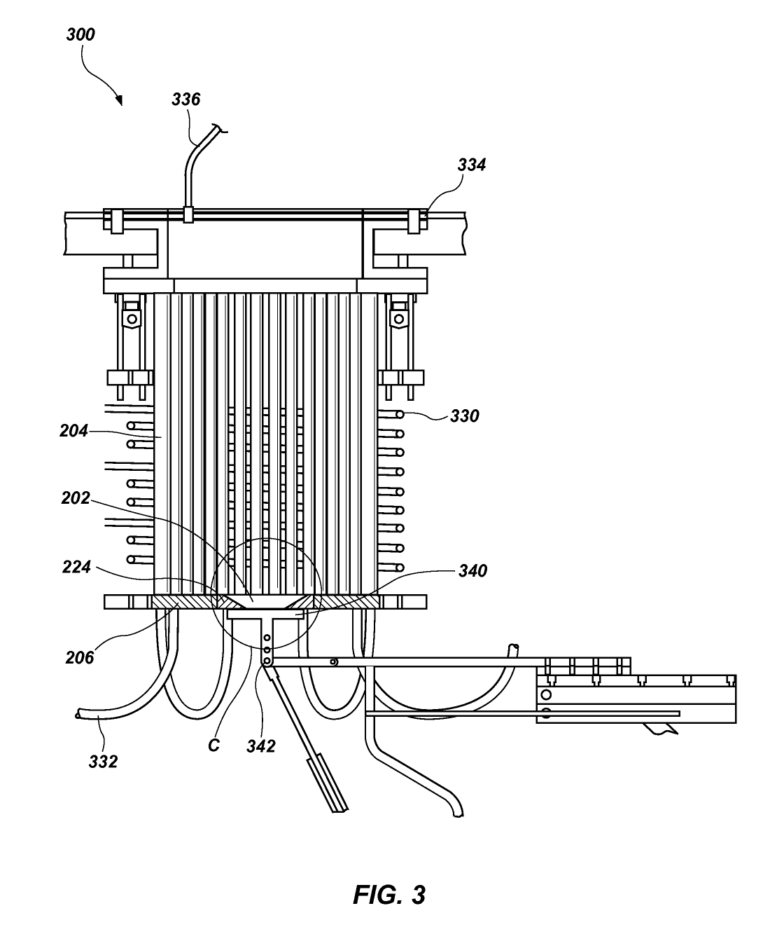

A chill plate 340 may be disposed adjacent to and in contact with the conductive material 224 and/or the bottom plate assembly 206 surrounding the orifice 202 of the crucible 300. The chill plate 340 may be connected to an articulating arm 342, such that the chill plate 340 may be moved during operation of the crucible 300. FIG. 4 shows the chill plate 340 in a position in which the chill plate 340 does not contact the conductive material 224. The articulating arm 342 may move the chill plate 340 out of a flow path of molten material from the crucible 300. The articulating arm 342 may connect to hinges, motors, and/or any other means for moving the chill plate 340.

The chill plate 340 may be configured to cool the conductive material 224 and/or the bottom plate assembly 206 when the chill plate 340 is in contact with the conductive material 224. The chill plate 340 may keep the conductive material 224 and/or the bottom plate assembly 206 cool such that the orifice 202 may remain closed when the chill plate 340 is in contact with the conductive material 224. The chill plate 340 may include a means for transferring heat from the conductive material 224 and/or the bottom plate assembly 206. For example, the chill plate 340 may include one or more fluid passageways and fittings configured to be connected to a source of cooling fluid (e.g., water), which may be the same or a different fluid than the fluid used to cool the walls of the crucible 300. In some embodiments, the chill plate 340 may include a thermoelectric device, such as a device configured to remove heat from the conductive material 224 and/or the bottom plate assembly 206 and transfer waste heat to the surroundings. The chill plate 340 may also be formed of, or include, a conductive material (e.g., a conductive metal, a conductive grease or sealant, etc.), such that heat may be efficiently transferred from the conductive material 224 and/or the bottom plate assembly 206 to the chill plate 340.

The chill plate 340 may be perforated to supply gases into the mixture from the bottom of the crucible 300 in order to effect change to the atmosphere and/or melt during the initiation and melt mixing phases. Gases could include, but are not limited to, inert-atmosphere gases such as nitrogen or argon, or chemical processing gases such as oxygen or propane.

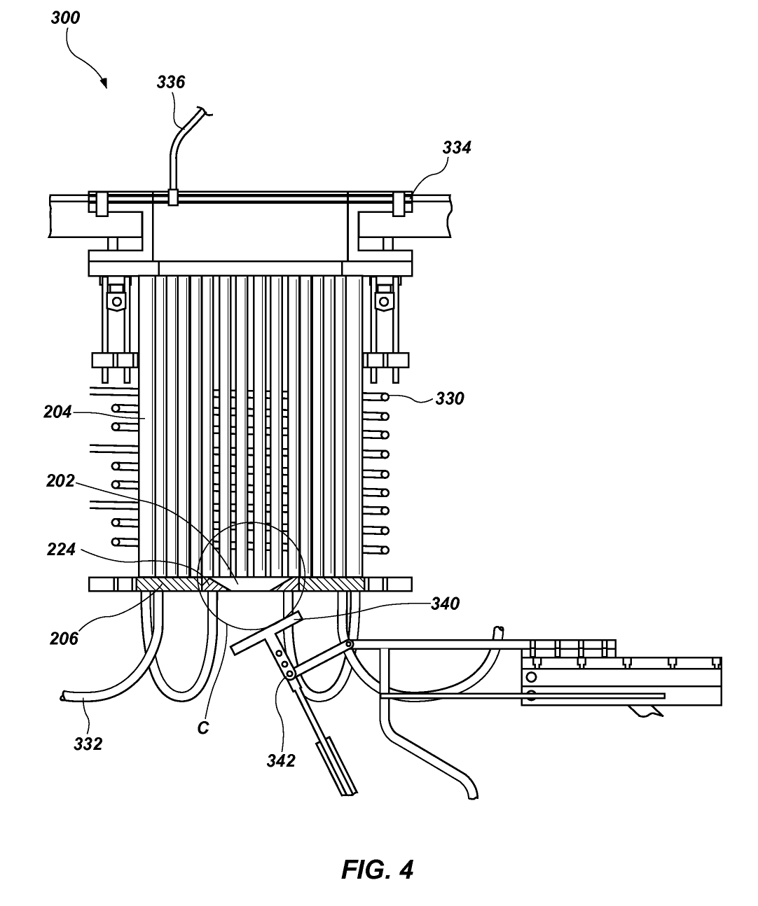

The crucible 300 may be used to receive material, such as in the form of solid powders, pellets, sludge, frit, or material bearing the form of liquids or slurries into the interior thereof. The material within crucible 300 is heated with the inductive source (e.g., the helical coil 330), causing the material to melt and mix in the crucible 300 via currents. During heating, the chill plate 340 may be held in contact with the conductive material 224, such that a portion of the material adjacent to and covering the orifice 202 solidifies (i.e., freezes) or remains solid. Once the material in the crucible 300 has been substantially heated and mixed, the molten material may be removed for use in a subsequent process (e.g., the material may be cast into a mold). To remove the molten material from the crucible 300, the articulating aim 342 may move the chill plate 340, as shown in FIG. 4. The conductive material 224 and the solid material over the conductive material 224 may then begin to heat, melting the solid material over the orifice 202. In some embodiments, an auxiliary heat source (e.g., heated air, electric resistance heat, etc.) may be provided to speed the heating process once the chill plate 340 has been moved. FIG. 5 illustrates an expanded detail view of a portion C of the crucible 300 with molten material 350 flowing through the orifice 202.

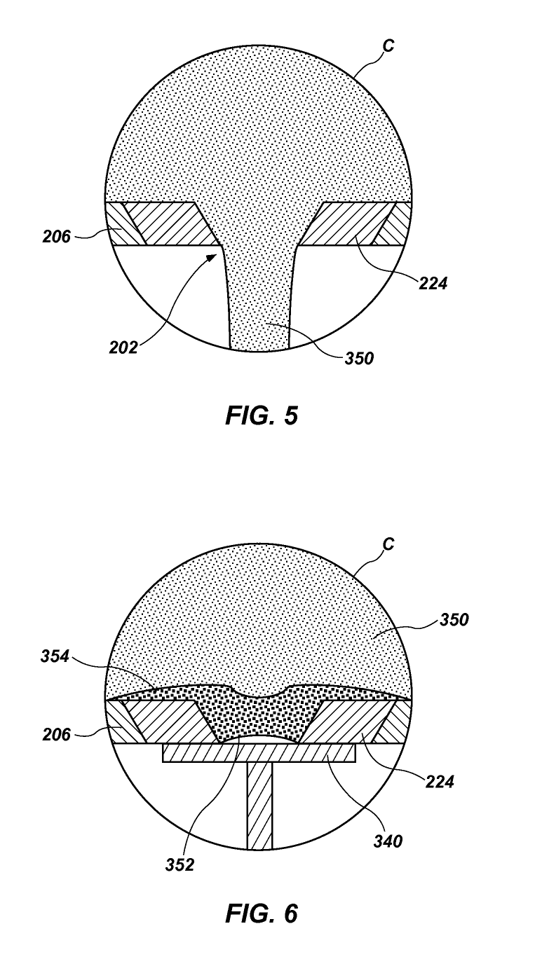

Flow of the molten material 350 may be terminated by applying a vacuum (i.e., a pressure less than atmospheric pressure) over the surface of the molten material within the crucible 300. For example, gases may be removed from the crucible 300 via fluid lines 336 (FIG. 4). When the vacuum above the molten material 350 reaches a value at which the force exerted on the molten material 350 by atmospheric pressure through the orifice 202 equals the force exerted on the molten material 350 by gravity and the pressure within the crucible 300, the flow of the molten material 350 slows and terminates. Additional vacuum may pull the molten material 350 back into the crucible 300, and may cause a meniscus 352 to form, as illustrated in FIG. 6. Vacuum may be provided by, for example, an induced draft fan controlled by a variable frequency drive.

Once the flow of molten material 350 has stopped, the chill plate 340 may be moved back into contact with the conductive material 224, and heat may be transferred from the conductive material 224 to the chill plate 340 (e.g., by conduction). This may cause some of the molten material 350 adjacent the orifice 202 to freeze again into a solid material 354 (FIG. 6). However, if the molten material 350 has been pulled back into the crucible 300 before moving the chill plate 340, the molten material 350 may not freeze to the chill plate 340, and therefore, the chill plate 340 may be easily removed again without diminishing the ability of the system to stop flow. That is, the chill plate 340 need not directly contact the molten material 350 because flow may be controlled by the vacuum until the solid material 354 forms. Once the chill plate 340 is in contact with the conductive material 224 and the solid material 354 has been formed, the pressure in the crucible 300 may be raised (e.g., to a pressure below, equal to, or above atmospheric pressure) without restarting flow of the molten material 350. In particular, the solid material 354 may prevent the molten material 350 from flowing through the orifice 202 so long as the chill plate 340 remains operational (e.g., cooling or removing heat) and in contact with conductive material 224.

Some of the molten material 350 may remain in the crucible 300 after a portion of the molten material 350 has been removed. Additional material to be melted may be added through a port in the top of the crucible 300 to make up for the molten material 350 removed. The crucible 300 may therefore be operated in a semi-continuous or hybrid mode having properties of both continuous and batch modes. Removal of molten material 350 from the crucible 300 may be initiated, controlled, and terminated multiple times while the crucible 300 is in operation (e.g., without substantial cool-down, cleaning, etc.). In particular, by leaving a portion of the molten material 350 within the crucible 300, time and energy typically spent in start-up and shut-down during batch operations can be limited or avoided. The time between discharges of the molten material 350 can be reduced, allowing for more steady operations (e.g., casting operations). Furthermore, quality control may be simplified because the material within the crucible 300 need not be drained all at once; therefore, changes in composition due to variations in feed stock may have relatively smaller influence on the composition of the molten material 350. Any such variations may be detected by testing the molten material 350 (e.g., testing a sample drawn from the orifice 202 before subsequent addition cycles) so that corrections can be made.

A vacuum applied above the molten material 350 may also be used, and varied, to control the flow rate of the molten material 350 at various levels. For example, flow of the molten material 350 may be increased or decreased as necessary, without stopping flow entirely. In some embodiments, additional material to be melted may be added to the crucible 300 while the molten material 350 is flowing from the crucible 300. In other embodiments, the material to be melted may be added during periods in which the molten material 350 is not flowing from the crucible 300 (e.g., when the chill plate 340 is in contact with the conductive material 224.

Material within the crucible 300 may be heated to any selected temperature. For example, material may be heated to a temperature of at least about 1000° C., at least about 1100° C., at least about 1200° C., at least about 1400° C., at least about 1600° C., or even at least about 2000° C. Because the walls may be cooled, a temperature profile may exist within the crucible 300, wherein material toward the centerline of the crucible 300 is at a higher temperature than material near the side wall 204. Similarly, a temperature profile may exist along a vertical line within the crucible 300. Temperature gradients may cause convection of the molten material 350 within the crucible 300, and may contribute to the formation of a molten material 350 of approximately uniform chemical composition.

The methods and devices disclosed herein may be used to process a variety of materials, such as radioactive waste, ceramics, alumina, zirconia, ruby-glasses, specialty glasses, cathode ray tube (CRT) glass recycling, high-temperature high-strength fiberglass, etc. The methods disclosed may be useful for limiting contamination in molten material by avoiding the use of refractory materials. The material being melted forms a skull along the wall, which may eliminate the need for refractory materials that may contaminate a high-purity melt. High-purity and crystalline phase retention may also be maintained by avoiding reheating of solidified material between cycles of material extraction. Thus, the methods may be particularly beneficial when high-purity products are desired. Because CCIM methods typically have high operating costs due to the necessity of using cooled walls, the methods disclosed may typically be relatively more economical for higher value-added processes (i.e., processes in which the material produced is much more valuable than the input material). For example, the methods may be economical for materials having melting points above about 1200° C.

Embodiments disclosed herein may allow withdrawal of material from the bottom of crucibles on multiple occasions without lowering the temperature, providing secondary heating around a tap hole, or mechanically opening a tap hole (e.g., by drilling, chipping, etc.) Therefore, a crucible may be maintained substantially continuously at an operating temperature, may be able to melt materials faster than conventional crucibles, and may be less likely to sustain damage in opening a tap hole. Embodiments may be particularly suitable for high-temperature melting processes in which intermittent bottom taps are desirable.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof. In addition, features from one embodiment may be combined with features of another embodiment while still being encompassed within the scope of the invention. Further, disclosed embodiments have utility with different and various crucible types and configurations, including vessels using other types of heat sources (e.g., electric arc furnaces, resistive heaters, etc.).

What is claimed is:

1. A crucible for melting material, comprising:
at least one wall at least partially enclosing a volume and including an orifice through a portion thereof; and
a chill plate supported for movement between at least a first position, wherein the chill plate is in contact with the portion of the at least one wall and covers the orifice, and a second position, wherein the chill plate is removed from contact with the at least one wall, and wherein the chill plate is configured for removal of heat from the portion of the at least one wall when the chill plate is in the first position.

2. The crucible of claim 1, wherein at least another portion of the at least one wall is configured to pass a cooling fluid adjacent the volume.

3. The crucible of claim 1, wherein the portion of the at least one wall adjacent the orifice comprises a thermally or electrically conductive material.

4. The crucible of claim 1, wherein the chill plate is supported for movement by a remotely controlled articulating device configured to move the chill plate between the first position and the second position.

5. The crucible of claim 1, wherein the portion of the at least one wall comprises a floor defining the orifice at a bottom of the volume.

6. The crucible of claim 1, wherein another portion of the at least one wall comprises a plurality of hollow tubes, and wherein the plurality of hollow tubes defines at least one coolant flow path through the at least one wall.

7. The crucible of claim 6, wherein the another portion of the at least one wall further comprises:
a substantially flat bottom plate; and
a plurality of O-rings, wherein at least one 0-ring of the plurality of O-rings is disposed between the substantially flat bottom plate and a tube of the plurality of tubes.

8. The crucible of claim 7, wherein each tube of the plurality of tubes can be connected to and disconnected from the bottom plate without welding or brazing.

9. A cold crucible for melting material, comprising:
a substantially flat bottom plate;
a plurality of hollow tubes above the substantially flat bottom plate proximate a periphery thereof; and
a plurality of O-rings;
wherein each hollow tube of the plurality of hollow tubes is in contact with at least one O-ring of the plurality of O-rings, and wherein each O-ring of the plurality of O-rings is in contact with the substantially flat bottom plate.

10. The cold crucible of claim 9, wherein the substantially flat bottom plate defines an orifice therethrough.

11. The cold crucible of claim 10, further comprising a chill plate mounted to move between at least a first position and a second position, wherein the chill plate is in contact with the substantially flat bottom plate and covering the orifice in the first position, wherein the chill plate is not in contact with the substantially flat bottom plate in the second position, and wherein the chill plate is configured for removal of heat from a portion of at least one wall when the chill plate is in the first position.

12. The cold crucible of claim 9, wherein the plurality of hollow tubes is configured to pass a cooling fluid therethrough.

13. The cold crucible of claim 9, further comprising a helical induction coil surrounding the plurality of hollow tubes.

14. A method of transferring molten material from a crucible, comprising:
moving a chill plate from a first position in contact with a floor of a crucible and covering an opening through the floor to a second position removed from the opening, wherein the crucible encloses a mass of molten material;
initiating flow of the molten material from the crucible through the opening;
terminating the flow of molten material from the crucible through the opening while a portion of the molten material remains in the crucible; and
moving the chill plate back to the first position.

15. The method of claim 14, wherein terminating the flow of molten material from the crucible comprises applying negative pressure to a surface of the molten material within the crucible.

16. The method of claim 14, wherein moving the chill plate back to the first position comprises freezing a portion of the molten material in the crucible adjacent the opening.

17. The method of claim 14, further comprising adjusting a flow rate of the molten material from the crucible by controlling a pressure within the crucible.

18. The method of claim 14, further comprising maintaining a temperature of the molten material within the crucible above about 1000° C. for a period of time.

19. The method of claim 14, wherein moving the chill plate back to the first position comprises contacting the chill plate with the floor of the crucible without contacting the chill plate with the molten material.

20. The method of claim 14, wherein the crucible comprises a plurality of hollow tubes and a bottom plate assembly that together enclose the mass of molten material, the method further comprising:
draining the crucible through the opening;
separating at least one hollow tube of the plurality of hollow tubes from the bottom plate assembly of the crucible;
attaching another hollow tube to the bottom plate assembly without welding or brazing; and
refilling the crucible.

21. A method of controlling flow of material from a crucible, comprising:
melting a portion of the material adjacent an opening in a wall of the crucible to initiate flow of molten material through the opening; and
providing a vacuum over the material in the crucible from a location opposite the opening.

22. The method of claim 21, wherein providing a vacuum over the material in the crucible comprises terminating flow of the molten material from the crucible while a portion of the molten material remains in the crucible.

23. The method of claim 21, further comprising covering the opening with a plate below the crucible without contacting the plate with molten material.
